(19) United States
(12) Patent Application Publication
(10) Pub. No.: US 2005/0162357 A1
(43) Pub. Date: Jul. 28, 2005

(54) Display device comprising a light guide

(75) Inventors: Gerardus Gegorius Petrus Van Gorkom, Eindhoven (NL); Peter Alexander Duine, Eindhoven (NL); Johannes Marra, Eindhoven (NL); Petrus Fransiscus Bongaerts, Eindhoven (NL); Johannes Gijsbertus Antonius Den Biggelaar, Eindhonve (NL); Roland Marinus Schuurbiers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/501,827

(22) PCT Filed: Jan. 14, 2003
(86) PCT No.: PCT/IB03/00067

(30) Foreign Application Priority Data
Jan. 22, 2002 (EP) 020752556

(51) Int. Cl. G09F 9/37; G09G 3/00

(52) U.S. Cl. 345/83; 345/30

(57) ABSTRACT

The invention relates to a display device (10) comprising a light guide (2) and a plate (4), which extend essentially parallel in a mutually spaced relationship, said display device further comprising a movable element (3) which is arranged between the light guide and the plate in a spaced relationship to the light guide, selection means (5, 6) to locally bring said movable element into contact with the light guide, and a number of spacing elements (13) arranged on the light guide or the plate for maintaining the space between the movable element and the light guide and the plate, respectively, characterized in that the spacing elements form an integral part of the movable element. The invention also relates to a method of producing the display device according to the invention.

The present invention relates to a display device comprising a light guide and a plate, which extend essentially parallel in a mutually spaced relationship, said display device further comprising a movable element which is arranged between the light guide and the plate in a spaced relationship to the light guide, selection means to locally bring said movable element into contact with the light guide, and a number of spacing elements arranged on the light guide or the plate for maintaining the space between the movable element and the light guide and the plate, respectively.

Such a display device is known from United States patent U.S. Pat. No. 4,113,360. In said patent, a description is given of a display device comprising a first plate of a fluorescent material, in which, in operation, light is generated and trapped (so that this plate forms a light guide), a second plate which is situated at some distance from the first plate and, between said two plates, a movable element in the form of a membrane. By applying voltages to addressable electrodes on the first and second plates and an electrode on the movable element, the movable element can be locally brought into contact with the first plate, or the contact can be interrupted. A transparent contact liquid is present on the contact surfaces. At locations where the movable element is in contact with the first plate, light is decoupled from said first plate. This enables an image to be represented. If the movable element is not in contact with the light guide, it is in contact with the second plate.

For a proper functioning of the display device, it is important that, on the one hand, the contact between the light guide and the movable element can be brought about and interrupted in an accurate and reliable manner, but that, on the other hand, the design is simple and does not require much energy to operate.

The known display device has the disadvantage that its production requires a relatively large number of steps and is as such complicated.

It is an object of the invention to provide a display device as described in the preamble, which is accurate, reliable and durable, but can be manufactured in a minimum number of processing steps.

The display device according to the invention is therefore characterized in that the spacing elements form an integral part of the movable element.

In a preferred embodiment of the display device, the movable element is divided into strips and the spacing elements form an integral part of the strips. Separating the membrane significantly reduces the effect known in the field as “crosstalk” or “cross-coupling”, because the number of neighbours of each strip is reduced to one or two neighbours, depending on the position of the strip. Advantageously, the number of selection means or drivers can be reduced, i.e. for a foil divided into x strips, the number of (row)drivers can be reduced by a factor x.

According to another preferred embodiment, a number of the strips is divided into sub-strips. The sub-strips may take the form of, for example, “bridges” comprising a pair of adjacent spacing elements and a part extending in between. Each bridge can be brought separately into contact with the light guide by the selection means. The dimensions of the resulting contact area can be made very small, providing the possibility of creating pixels of comparably small dimensions. Furthermore, these membrane bridges are attached on two opposite sides only, leading to a reduction of the force which is necessary to establish the optical contact with the light guide and therefore a reduction of the electric power which is necessary for operating the display device. Since the bridges are separate entities, the effect of crosstalk is eliminated by this feature. The accuracy and reliability of the display device is thus greatly improved.

In a further preferred embodiment, a number of the sub-strips comprises one spacing element at one end thereof, the opposite end of the sub-strip being freely movable. As these membrane “diving boards” are now only attached on one side, the force which is necessary to establish the optical contact with the light guide is further minimized which directly results in an even further minimization of the electric power which is necessary for operating the display device.

In order to reduce the internal stress, the sub-strips may comprise one or more cut-out parts. As an alternative thereto, the sub-strips may comprise areas having different degrees of flexibility.

In yet another preferred embodiment, the spacing elements extend in a direction which is essentially perpendicular to the longitudinal direction of the strips. In this embodiment, the spacing elements are shortest, thus allowing the movable element to move more freely. Advantageously, the force mentioned earlier and consequently also the electric operating power are thereby reduced greatly. Furthermore, this embodiment allows the definition of a row pattern of selection means on top of the strips.

According to another preferred embodiment, the selection means comprise electrodes which are arranged on the movable element, said electrodes comprising a reflective material. The reflective material ensures the reflection of light to one side of the display, thus increasing the lumen efficacy. The lumen efficacy can be further improved by integrating the colour filters which are normally present in the display device in the movable element, for example in the strips.

In an alternative preferred embodiment, the spacing elements are arranged at the plate and the display device further comprises a number of supports arranged on the light guide for maintaining the space between the movable element and the light guide. Unwanted absorption is now advantageously reduced. Furthermore, in this arrangement, the optical contact surface of the movable element is now accessible and important parameters, such as hardness and roughness, can be processed, thus allowing fine tuning of the most critical part of the display device.

The invention also relates to a method of producing a display device according to the invention in a minimum number of steps. Said method comprises the steps of arranging a first set of electrodes (on a substrate), covering the electrodes with a layer of insulating material, arranging a layer of sacrificial material on the insulating layer defining a pattern for the movable element, arranging a layer of material for the movable element on the insulating layer and the sacrificial layer, structuring the movable element layer, arranging a second set of electrodes on the movable element layer, and removing the sacrificial layer. Advantageously, the number of method steps is further reduced by structuring the second set of electrodes and the movable element layer simultaneously in one step.

The invention will be further explained by means of the attached drawings, in which:

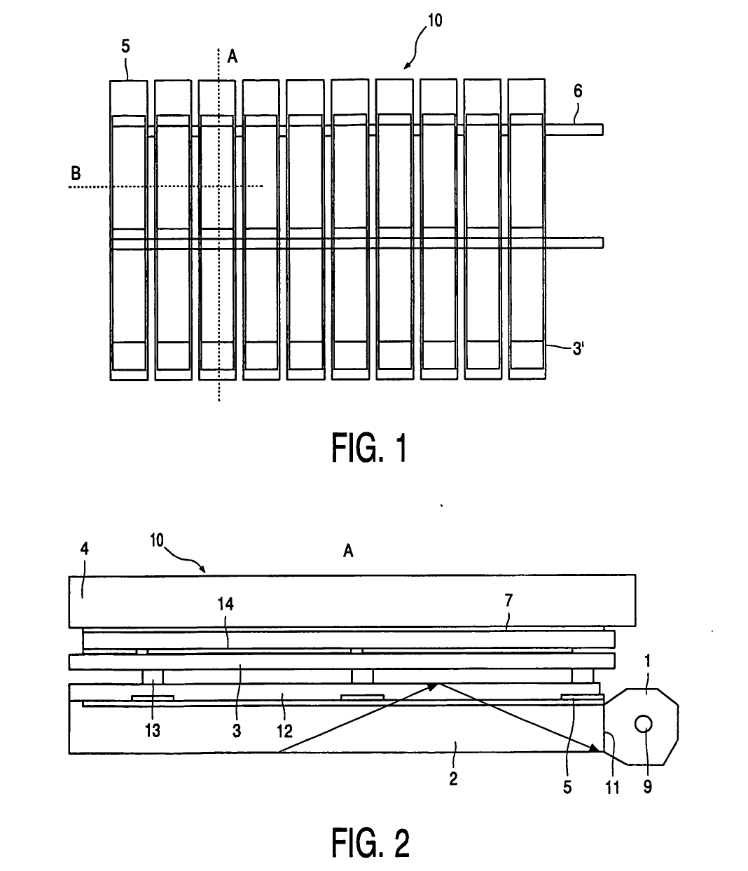

FIG. 1 is a diagrammatic top view of part of a first preferred embodiment of a display device according to the invention;

FIG. 2 is a cross-sectional view of the embodiment of FIG. 1, taken on the line A;

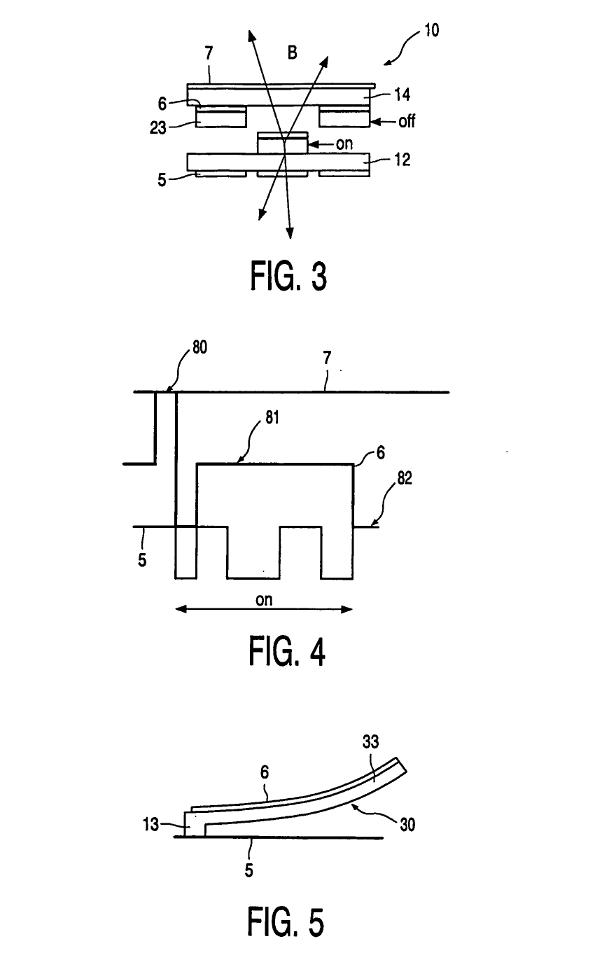

FIG. 3 is a cross-sectional view of the embodiment of FIG. 1, taken on the line B;

FIG. 4 shows an example of an addressing scheme for the first preferred embodiment;

FIG. 5 is a side view of an alternative embodiment for the movable element forming part of a second preferred embodiment of a display device according to the invention;

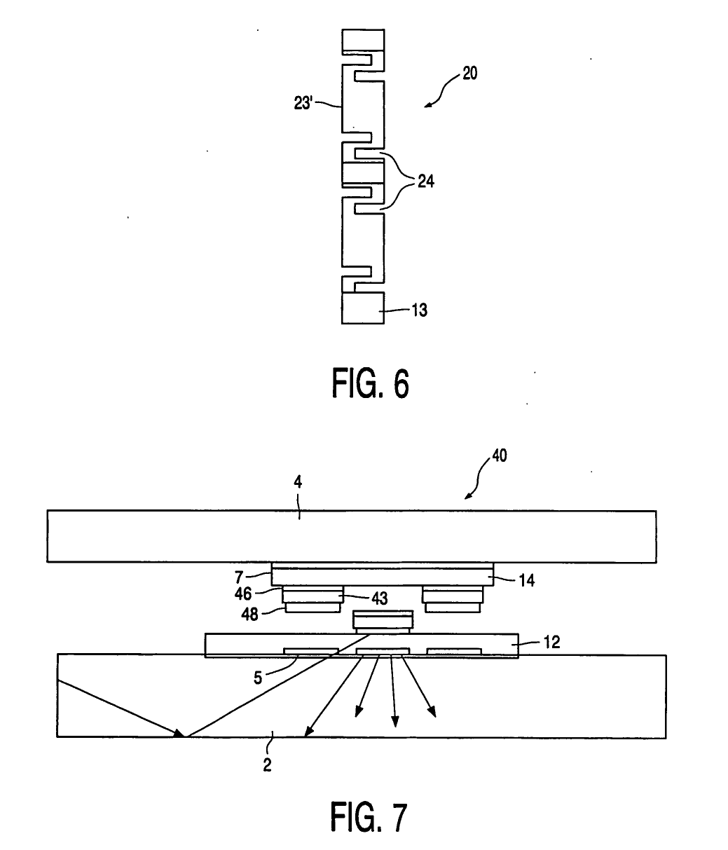

FIG. 6 is a top view of another alternative embodiment for the movable element forming part of a third preferred embodiment of a display device according to the invention;

FIG. 7 is a cross-sectional view of a fourth preferred embodiment of a display device according to the invention;

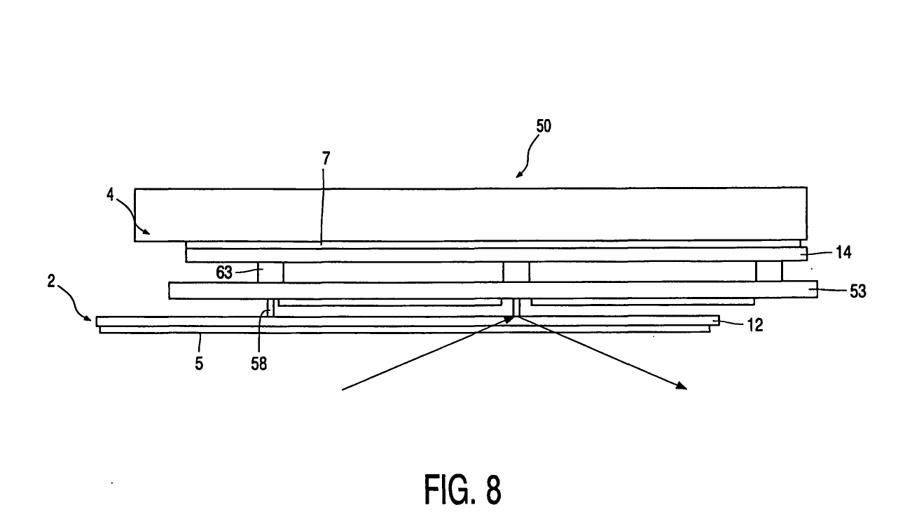

FIG. 8 is a cross-sectional view of a fifth preferred embodiment of a display device according to the invention;

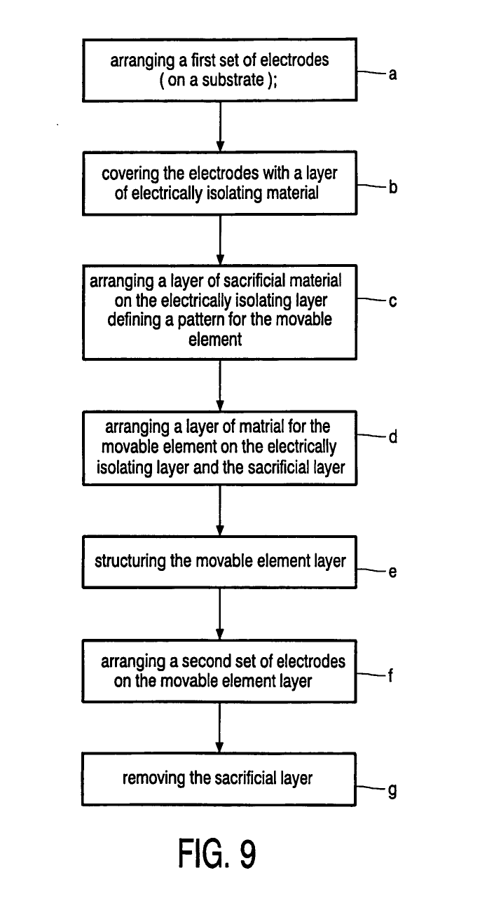

FIG. 9 shows a flow chart illustrating the steps of the method according to the invention;

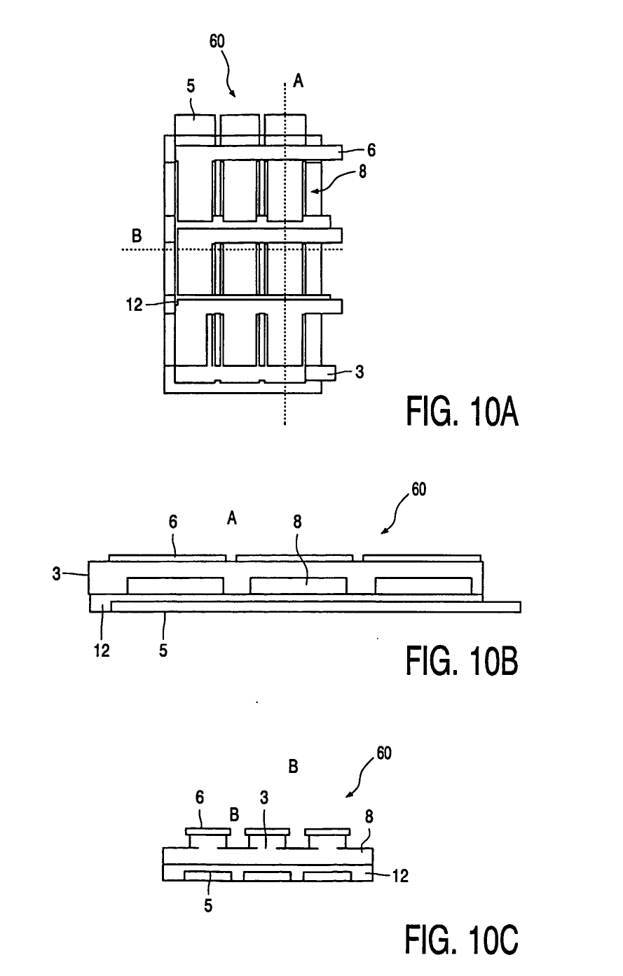

FIG. 10A schematically illustrates the basic steps according to the method according to the invention in a top view;

FIG. 10B illustrates the basic steps of FIG. 10A in a cross-section taken on the line A;

FIG. 10C illustrates the basic steps of FIG. 10A in a cross-section taken on the line B; and

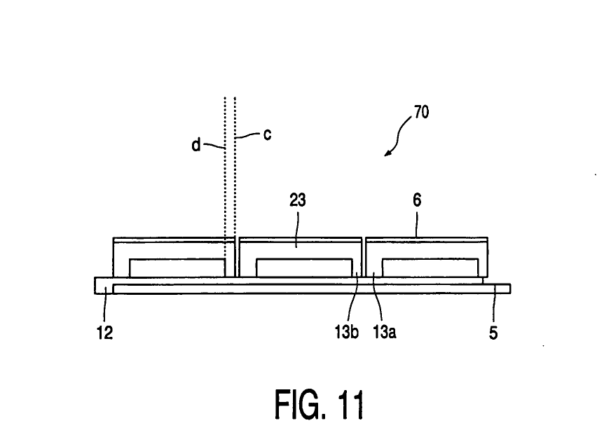

FIG. 11 illustrates a display device resulting form a preferred embodiment of the method according to the invention, schematically in a cross-section.

In all Figures, identical reference numerals are used to denote identical components. FIG. 1 is a diagrammatic top view of a first preferred embodiment of a display device 1 according to the invention. FIG. 2 is a cross-sectional view of the display device 1 taken on the line A, whereas FIG. 3 is a cross-sectional view of the display device 1 taken on the line B.

Display device 10 comprises a light guide 2, a movable element 3 and a second plate 4. Electrode systems 5 and 6 are arranged on the surface of the light guide 2 facing the movable element 3 and on the surface of the movable element 3 facing the second plate, respectively.

The surface of the second plate is provided with a common electrode 7. Preferably, the common electrode 7 comprises a conducting layer. Such a conducting layer may be a semi-transparent metal layer, such as a semi-transparent aluminium layer, a layer of a transparent conducting coating such as indium tin oxide (ITO) or a mesh of metal tracks. It is noted that in the embodiment having integrated colour filters in the spacers (as shown in FIG. 7) the common electrode need not be transparent, because the row electrodes are reflective. In this embodiment, standard conducting material such as copper may be used.

In this example, the light guide is formed by a light-guiding plate 2. The light guide may be made of glass. The movable element may be made of a transparent polymer having a glass transition temperature of at least the operating temperature of the display device in order to prevent non-elastic deformation of the movable element. Practically, the operating temperature of the display device is in the range between about 0 and 70° C. A suitable transparent polymer is, for example, parylene which has a glass transition temperature of 90° C.

The electrodes 5 and 6 form two sets of electrodes which cross each other at an angle of preferably 90°. By locally generating a potential difference between the electrodes 5, 6 and the movable element 3, by applying, in operation, voltages to the electrodes and the movable element 3, forces are locally exerted on the movable element, which pull the movable element against the light guide 2 or against the second plate 4.

The display device further comprises a light source 9 and a reflector 1. Light guide 2 has a light input 11 in which light generated by the light source 9 is coupled into the light guide 2. The light source may emit white light, or light of any colour, depending on the device. It is also possible that more than two light sources are present, for instance, a light source on two sides or on each side of the device. It is also possible to use light sources of different colours sequentially to form a white light display.

The movable element 3 is positioned between the light guide 2 and the second plate 4 by means of spacers 13. Electrodes 5 and common electrode 7 are covered by respective insulating layers 12 and 14 in order to preclude direct electric contact between the movable element 3 and the electrodes. By applying voltages to the electrodes and the movable element, an electric force is generated which pulls the movable element against the electrode 5 on the light guide 2. The electrode 5 is transparent. The contact between the movable element and the light guide causes light to leave the light guide and enter the movable element at the location of the contact. In the movable element, the light is scattered and part of it leaves the display device via the transparent electrode 5 and the light guide 2 and a part leaves through the second plate 4. It is also possible to use one set of transparent electrodes, the other being reflective, which increases the light output in one direction.

According to the invention, spacing elements 13 form an integral part of the movable element 3. The movable element 3 is divided into strips 3′, as can be seen in FIGS. 1 and 3, which are in turn divided into sub-strips 23. The spacers 13 are arranged on two opposite sides of a sub-strip 23, preferably on the shortest sides when the sub strip 23 has a rectangular shape. Thus, each sub strip 23 forms a “bridge”. Since each sub strip 23 corresponds to a pixel of the display device, the pixel size is effectively reduced.

In operation, the light travels inside the light guide and, due to internal reflection, cannot escape from it, unless the situation as shown in FIG. 3 occurs. FIG. 3 shows the movable element 23 lying against the light guide 2. In this state, a part of the light enters the movable element. This movable element scatters the light, so that it leaves the display device. The light can exit at both sides or at one side. In FIG. 3, this is indicated by means of arrows.

It can be calculated that, for an optical contact area of 50%, roughly 10% of the normal voltage difference is needed to connect a bridge to the light guide, which amounts to approximately 7.5 V, and even less than a third of that (˜2 V) to connect a diving board to the light guide.

Generally, the spacing elements 13 extend essentially parallel in a direction (B) that lies essentially perpendicular to the direction of the strips.

FIG. 4 shows an example of an addressing scheme for the display device 1. As the passive plate has an unstructured common reference electrode 7 and the foil electrodes are used as row electrodes, the method of robust addressing can be used. A detailed description of this technique can be found in PHNL000059 EP-P, which is an earlier patent application in the name of the same applicant. This method of robust addressing is very interesting, because it allows switching the bridges on or off with a single force acting on the structure. This will minimize the effect of pixel spread on the required addressing voltages because balancing two opposite forces will generally amplify the variation in foil switching behaviour. FIG. 4 shows three addressing states
a first addressing state “Robust on” 80,
a second addressing state “Nothing happens due to bi-stability” 81, and
a third addressing state “Robust off” 82.
   The three lines indicate the voltages on the column electrode 5, the row electrode 6 and the common electrode 7. It can be seen that, during switching, only a single force acts on the pixel.

FIG. 5 schematically shows an alternative embodiment for the movable element 3. As an alternative to the bridges, a number of sub strips may comprise one spacer 13 at one end thereof, the opposite end of the sub strip 33 being freely movable. Thus, each sub strip 33 forms a “diving board”. As each sub strip 33 corresponds to a pixel of the display device, pixel size is effectively reduced in this case as well. It can be calculated that, for an optical contact area of 50%, less than 30% of the normal voltage difference is needed for a diving board, which amounts to approximately 2 V.

FIG. 6 is a top view of another alternative embodiment for the movable element. In FIG. 6, an alternative embodiment of two sub strips 23′ provided with cut-out parts 24 is shown. The cut-out parts 24 further reduce the stiffness of the bridge, which is mainly determined by the bending stiffness. In this example, the sub strips are bridges 23′, but it will be apparent to a person skilled in the art that the cut-out parts can also be applied to the described diving boards. As illustrated by the position of the diving board in FIG. 5, diving boards may suffer from deflection due to internal stress. As an alternative to the cut-outs, the sub strips may comprise elastic parts, the Young's modulus for different areas in the sub strip being different. For example, the Young's modulus may be lower in certain areas where stiffness is required, whereas the Young's modulus may be higher in other areas where a higher bending elongation is required.

FIG. 7 is a cross-sectional view of a fourth preferred embodiment of a display device 40 according to the invention. Row electrodes 46 comprise reflective material. Some examples of suitable reflective material are Al or Ag. The reflective electrodes reflects the light that normally escapes from the passive side of the display, thereby increasing the lumen efficacy by a factor of 2.

In addition thereto, display device 40 comprises a number of colour-determining elements 48 that form part of the movable element 3, more specifically the (sub) strips 43, which can either be bridges or diving boards. These elements may be, for example, colour filter elements allowing light of a specific colour (red, green, blue, etc.) to pass. The colour filter elements have a transparency of at least 20% for the spectral bandwidth of a desired colour of the incoming light and a transparency in the range between 0 and 2% for other colours of the incoming light. It is noted that both the sub strip and the colour filter preferably have a thickness that is approximately only half the normal thickness.

In an alternative embodiment, the row electrodes comprise ITO and the colour filter material is applied on the plate. Although this alternative embodiment is less efficient, because only 50% of the light is put to use, it allows creating coloured light and the use of the robust addressing method. It will be clear that the electrodes on the movable element should be transparent.

As another alternative, a UV lamp may be used to feed UV light into the light guide that leaves the light guide and is incident on phosphor elements. The phosphor elements excited by the UV light emit coloured light. The use of UV light and phosphor elements increases the efficiency of the display device. In still another embodiment, a light source emitting blue light may be used. The blue light is fed into the light guide and leaves the light guide and is incident on phosphor elements, converting the blue light into red and green light. In this way, a very efficient conversion of the applied light is obtained.

FIG. 8 is a cross-sectional view of a fifth preferred embodiment of a display device 50 according to the invention. In display device 50, the spacers 63 are arranged at the plate 4. In addition thereto, the display device 50 further comprises a number of supports arranged on the light guide 2 for maintaining the space between the movable element 3 and the light guide 2.

In the fifth embodiment, the top surface of the sub strips 53 is used to extract light from the light guide. Since the spacers 63 do not contact the light guide, unwanted light absorption is reduced. Furthermore, this concept allows processing of the surface of the sub strips. Features such as roughness and hardness of the most critical part of the sub strips can now be fine-tuned.

A method of producing the display device according to the invention will be described hereinafter. The method according to the invention comprises the following basic steps and is illustrated by means of an embodiment 60 in FIGS. 10A, B and C.

Step a) Arranging a First Set of Electrodes.

In general, a layer of electrically conducting material, preferably indium-tin oxide (ITO), is applied on a suitable substrate and a pattern defining the shape of the electrodes is arranged in the electrically conducting layer. In the text and the Figures, the first set of electrodes is referred to as column electrodes 5. The techniques to accomplish this step are known in the art.

Step b) Covering the Electrodes with a Layer of Insulating Material.

Preferably, a suitable dielectric material is used, such as SiO2, preferably having a thickness of essentially 1 μm. In the Figures, the resulting insulating layer is referred to as 12.

Step c) Arranging a Layer of Sacrificial Material on the Insulating Layer.

The sacrificial layer 8 serves to define a pattern for the movable element. More specifically, the sacrificial layer defines the space between the movable element in the rest state and the contact areas on the light guide. Examples of suitable materials for the sacrificial layer are Al and Cu and/or, in general, all easily etchable materials, such as glucose. Preferably, the sacrificial layer has a thickness of essentially 1 μm. The pattern is defined by means of known techniques.

Step d) Arranging a Layer of Material for the Movable Element

In this step, a layer of material for the movable element 3, which is also referred to as foil material, is arranged on the insulating layer and the sacrificial layer. The foil material is arranged on and around the sacrificial layer, such that the spacing elements 13 supporting the movable element will form an integral part of the movable element. Examples of suitable materials for the foil layer are known in the art and are, for instance, described in earlier patent applications in the name of the same applicant, such as WO 99/28890, which is incorporated herein by reference. Preferably, a polymer material comprising scattering particles, such as polyimide-TiO₂ or parylene-TiO₂ is used. The techniques for this step, such as spinning techniques, are available in the art.

Step e) Structuring the Movable Element Layer.

The foil layer is structured by known structuring techniques, such as photolithography for structuring polyimide-TiO₂ or dry-etching for structuring parylene-TiO₂. In this step, the movable element can optionally be divided into strips.

Step f) Arranging a Second Set of Electrodes on the Movable Element Layer

This step is similar to step a) described hereinbefore. In the text and the Figures, the second set of electrodes is referred to as row electrodes 6.

Step g) Removing the Sacrificial Layer.

The sacrificial layer 8 is now removed by known techniques, such as etching techniques.

FIG. 11 is a cross-section of a display device 70 resulting from a preferred embodiment of the method according to the invention. According to this preferred embodiment, the second set of electrodes and the movable element layer are structured simultaneously in one step. Consequently, the layout of the foil 3 and the layout of the row electrodes 6 are equal, i.e. a division of the strips into sub strips, such as bridges 23, each having a set of spacers 13a, 13b, as is shown in FIG. 11. For this embodiment, the technique of robust addressing mentioned hereinbefore can be used advantageously.

The method described above may also be used to produce a display device having diving boards. According to a further preferred embodiment, the step of simultaneous structuring is performed in such a way that the foil 3 and the row electrodes 6 are subdivided along the line d instead of line c. In that case, the resulting sub strips are diving boards, each only having one spacer 13, most of which are composed of the adjacent spacers 13a and 13b.

In order to minimise bending stress of the sub strips, more specifically the diving boards, (foil and electrode)-material can be removed in the large bending stress area in an additional step. Alternatively, the Young's modulus of certain areas can be lowered. To this end, selective photo-polymerisation of the sub strips can be applied at areas where a higher stiffness is useful (e.g. to prevent van der Waals sticking). At other areas, where the bending elongation should be maximal, one should refrain from x-linking.

The colour filters mentioned hereinbefore can be integrated in the foil by means of techniques known per se in the art.

It is noted that the terms “row” and “column” are interchangeable throughout this text.

Furthermore, the invention is of course not limited to the described or shown embodiments. As an alternative, the row electrodes can be arranged on the passive plate, in which case the foil electrodes can be connected to form sub-sets. This allows a reduction of the row drivers.

The invention thus generally extends to any embodiment, which falls within the scope of the appended claims as seen in light of the foregoing description and drawings.

1. A display device (10; 20; 30; 40; 50; 60; 70) comprising a light guide (2) and a plate (4), which extend essentially parallel in a mutually spaced relationship, said display device further comprising a movable element (3; 23; 33; 43; 53) which is arranged between the light guide and the plate in a spaced relationship to the light guide, selection means (5, 6) to locally bring said movable element into contact with the light guide, and a number of spacing elements (13; 63) arranged on the light guide or the plate for maintaining the space between the movable element and the light guide and the plate, respectively, characterized in that the spacing elements form an integral part of the movable element.

2. A display device as claimed in claim 1, wherein the movable element is divided into strips (3′) and the spacing elements form an integral part of the strips.

3. A display device as claimed in claim 1, wherein a number of the strips is divided into sub-strips (23; 33; 43; 53).

4. A display device as claimed in claim 3, wherein a number of the sub-strips comprises a pair of adjacent spacing elements (13) and a part (23; 33; 43; 53) extending in between.

5. A display device as claimed in claim 3, wherein a number of the sub-strips (33) comprises one spacing element at one end thereof, the opposite end of the sub-strip being freely movable.

6. A display device as claimed in claim 3, wherein the sub-strips comprise one or more cut-out parts (24).

7. A display device as claimed in claim 3, wherein the sub-strips comprise areas having different degrees of flexibility.

8. A display device as claimed in claim 1, wherein the spacing elements extend in a direction which is essentially perpendicular to the longitudinal direction of the strips.

9. A display device as claimed in claim 1, wherein the selection means comprise electrodes (46) which are arranged on the movable element (43), said electrodes comprising a reflective material.

10. A display device as claimed in claim 1, comprising a number of colour filters (48) which form part of the movable element (43).

11. A display device as claimed in claim 1, wherein the spacing elements (63) are arranged at the plate, the display device further comprising a number of supports (58) arranged on the light guide for maintaining the space between the movable element and the light guide.

12. A method of producing a display device according to claim 1, the method comprising the steps of:
a) arranging a first set of electrodes on a substrate;
b) covering the electrodes with a layer of insulating material;
c) arranging a layer of sacrificial material on the insulating layer defining a pattern for the movable element;
d) arranging a layer of material for the movable element on the insulating layer and the sacrificial layer;
e) structuring the movable element layer;
f) arranging a second set of electrodes on the movable element layer; and
g) removing the sacrificial layer.

13. A method as claimed in claim 12, wherein the second set of electrodes and the movable element layer are structured simultaneously in one step.
